(19) United States
(12) Patent Application Publication
(10) Pub. No.: US 2023/0263100 A1
(43) Pub. Date: Aug. 24, 2023

(54) Method of Stem Grafting and an Apparatus for Performing the Method

(71) Applicants: Hendrik Baars, IJzendoorn (NL); Gerrit Baars, Kesteren (NL)

(72) Inventors: Hendrik Baars, IJzendoorn (NL); Gerrit Baars, Kesteren (NL)

(21) Appl. No.: 18/111,773

(22) Filed: Feb. 20, 2023

(30) Foreign Application Priority Data
Feb. 21, 2022 (NL) 1044265
Jul. 21, 2022 (NL) 1044385
Nov. 24, 2022 (NL) 1044475

(51) Int. Cl. A01G 2/32; A01G 2/35

(52) U.S. Cl. CPC A01G 2/32; A01G 2/35

(57) ABSTRACT

The invention relates to a method of stem grafting a scion to a stock, wherein an end for grafting of an element chosen from i) a proximal end of the scion and ii) a distal end of the stock is shaped to result in a shaped primary end, and the end for grafting of the other element is provided with a complementary a cut-out. To achieve stem grafting conveniently and reliably, the primary end and the secondary end at least the cut-out of the secondary end is obtained by machining using a milling bit. The invention also relates to an apparatus for performing the method.

### CROSS-REFERENCE TO RELATED APPLICATIONS

This application claims priority to The Netherlands Patent Application Nos. 1044265 filed Feb. 21, 2022, 1044385 filed Jul. 21, 2022, and 1044475 filed Nov. 24, 2022, the disclosures of which are hereby incorporated by reference in their entireties.

### BACKGROUND OF THE INVENTION

### Field of the Invention

The invention concerns a method of stem grafting a scion to a stock, wherein the method comprises the steps of
shaping an end for grafting of an element chosen from i) a proximal end of the scion and ii) a distal end of the stock to result in a shaped primary end, and
providing the end for grafting of the other element with a cut-out, wherein said cut-out extends
in a longitudinal direction of the other element at a circumferential side thereof, and
through the bark of the other element so as to result in a secondary end; said cut-out of the secondary end being complementary to the primary end, and
inserting the primary end in the complementary cut-out of the secondary end.

### Description of Related Art

Grafting is well known in the art to obtain a plant (tree) by vegetative (asexual) propagation. The resulting plant has the advantages of the stock (which comprises the root system), such as a good ability to extract nutrients from the soil, plus the advantages of the scion, such as a good ability to provide desirable fruits.

The cut-out is typically a wedge-shaped cut-out, in particular a wedge-shape tapered in a longitudinal direction of the element and tapered in a plane perpendicular to said longitudinal direction. As forming wedge-shaped ends and in particular wedge-shaped cut-outs requires lots of craftsmanship, in the state of the art use is made of a more simple form of grafting called whip grafting. In whip grafting the scion and the stock are cut slanting and then joined. Because grafting involves the joining of vascular tissues (bark) between the scion and stock so as to allow the flow of sap rich in inorganic nutrients from the stock to the scion (and of sap rich in sugar from the scion to the stock), a disadvantage of whip grafting is that the diameter of the stock and the scion have to be matched well to increase the chance of a successful graft.

### SUMMARY OF INVENTION

The invention concerns a method according to the preamble wherein stem grafting is achieved conveniently and reliably.

According to the invention, of the primary end and the secondary end at least the cut-out of the secondary end is obtained by machining using a milling bit.

Thus the cut-out can be provided with great accuracy, conveniently and/or more quickly than with craftsmanship.

Preferably, the primary end is received in the secondary end such that bark of the primary end abuts machined bark of the secondary end. While a minor gap may be permissible, this may increase the risk of failure that the scion will grow successfully.

Typically, after the step of inserting the primary end in the complementary cut-out of the secondary end, the scion and the stock are fixed together so as to allow the wound to heal. Fixing may be done using any method known in the art, such as tying a rope or band around the joined ends.

While the cut-out may be machined using a shaving motion with the milling bit, for example using a reciprocating linear movement of the milling bit and/or a plurality (series) of in-line placed milling bits, it is preferred if the machining comprises milling with the milling bit.

In the present application, for a given element the terms proximal and distal are used based on the direction of the normal flow of inorganic nutrients in the bark of the plant from proximal to distal.

Preferably, the milling bit for forming the cut-out has a first cutting edge and a second cutting edge, said cutting edges being at an angle α of less than 170° for forming a wedge-shaped cut-out.

Thus both surfaces defining the wedge-shaped cut-out are formed simultaneously, speeding up the grafting process, which helps to improve the chance that the scion will grow successfully, for example by reducing the risk of drying out, clogging or other process that interferes with transport of nutrients along the vascular system of the plant.

The angle α is typically at least 10°.

The wedge-shaped cut-out is preferably tapered in a longitudinal direction of the element and tapered in a plane perpendicular to said longitudinal direction complementary to the wedge-shaped end.

It is preferred that the milling bit has a distal end, the milling bit is rotated about an axis wherein the distal end of the milling bit defines a plane of rotation, the milling bit is off-center with respect to the axis of rotation and its distal end facing away from the axis of rotation, wherein before milling the element and the plane are positioned relatively to each other with the centerline of the element in said plane and while milling the element and the axis of rotation are moved relative to one another along a line of movement with the centerline of the element in said plane of rotation in a direction from the end for grafting of the element to an opposite end of the element wherein the line of movement intersects the centerline of the element.

Thus the two faces of the wedge-shaped cut-out with a taper in a longitudinal direction of the element and a taper in a plane perpendicular to said longitudinal direction can be formed conveniently and quickly.

According to an important embodiment of the invention, milling the primary end comprising milling using a milling bit comprising a multitude of machining blades, the machining blades having distal ends equidistant to the axis of rotation and distributed over the rotational direction of the milling bit, wherein the machining blades are separated by guide surfaces and wherein for a given location on the axis of rotation the radial distance between the distal end of a machining blade and the guide surfaces is between 0.05 and 1.5 mm, preferably between 0.1 and 0.5 mm and more preferably between 0.15 and 0.4 mm.

Thus the risk of the formation of a fibrous/flossy end at the primary end is reduced, in particular for primary ends having a thickness of 15 mm or less. The guide surfaces serve as a stop should the primary end and in particular a relative thin portion thereof start to vibrate during machining. The machined surfaces are smoother facilitating the grafting operation. A milling bit comprises a machining blade, and typically multiple machining blades (cutters), with at the upstream side of a machining blade a recess (gullet) facilitating the discharge of cutting debris. According to the present invention, the distance from the leading edge of a machining blade to the upstream guide surface is in a circumferential direction less than 2 mm, preferably less than 1 mm.

According to a preferred embodiment, in a first milling step the shaped primary end is formed
in a first step involving rotating a first milling bit having guide surfaces to form a first cut surface, and
in a second step involving rotating a second milling bit having guide surfaces to form cut surfaces complementary to the wedge-shaped cut-out.

Thus method becomes more convenient and reliable. This embodiment also allows to maintain the end at the primary end formed in the first step during the second step, effectively forming a blunt end at the primary end.

Preferably, the cutting edges of the milling bit are at opposite sides of a plane perpendicular to the axis of rotation and conveniently at an angle of α/2 to said plane.

The point of intersection of the line of movement and the centerline of the element may be inside or outside the element. The angle of intersection β is typically between 2° and 45°, preferably between 5 and 35°, more preferably between 10 and 25°.

It is preferred that the angle α is less than 100°, preferably between 15° and 60° and more preferably between 20° and 45°.

These are angles that can be machined conveniently and allow for successful graft formation.

It is preferred that the primary end is obtained by machining using at least one milling bit, the at least one milling bit comprising two cutting edges at an angle to provide shaped primary end complementary to the cut-out of the secondary end.

This allows for even more convenient, successful and/or quick grafting.

The milling may be performed using a milling head comprising two adjacent milling bits, each providing one of the two cutting edges for providing the primary end. For the best results, it is preferred that the milling bits are not mounted in a rotationally displaced manner with respect to each other. However, it is possible that the milling head comprises more than one pair of milling bits which pairs are mounted rotationally displaced but not axially displaced with respect to any other pair of milling bits.

It is preferred that the wedge-shaped cut-out is machined with an angle α′, and the complementary wedge-shaped primary end is machined with an angle α″, wherein the difference between angle α″ and angle α′ is between +0.2° and 3°, preferably between +0.3° and 1°.

This allows the cut-out of the secondary end to clamp onto the complementary wedge-shaped primary end.

It is preferred that the apex of the primary end in a plane perpendicular to the longitudinal direction of the other element is at a distance from the other element.

This helps to prevent the other element from being split when clamping the primary end in the complementary cut-out of the secondary end, i.e. typically clamping the scion into the stock.

It is preferred that the milling head comprises a second bit for cutting the apex of the primary end.

This renders the apex blunt and helps to reduce the risk of the secondary end from splitting.

It is preferred that the nadir of the cut-out is in a plane perpendicular to the longitudinal direction of the other element rounded with a radius of at least 0.2 mm.

This helps to prevent the other element from being split when clamping the primary end in the complementary cut-out of the secondary end, i.e. typically clamping the scion into the stock. The radius is typically at least 0.2 mm, preferably at least 0.5 mm and the radius is typically less than 3 mm.

It is preferred that the thickness of at least the thinnest of the element and the further element is determined using an auxiliary device and the thickness value that is determined is used in the control of the machining bit.

This allows for the preparation of matching shapes of the primary end and the cut-out. By way of example and as typically will be the case, the scion has the smallest thickness. It thickness will correspond to the largest depth of the cut-out of the secondary end.

The auxiliary device may be calipers, a camera with an image processing module, or an optoelectronic sensor (which may comprise a light source such as a laser or a LED and light detector which may work in conjunction with a belt (speed) along which an element is supplied to the machining bit.

It is preferred that the secondary end of the other element is provided with a band across the cut-out before inserting the primary end of the element.

This has been found to work very convenient as there is no risk of losing the element. It works in particular well with cut-outs having an angle α of less than 45°.

The band may be an elastomeric band such as a rubber band, or tape, such as paper tape.

It is preferred that the milling bits are rinsed during and/or after cutting with an aqueous liquid supplied via at least one supply conduit.

This helps to ensure continuous operation in case sap from the scion and/or stock contaminates the milling bits. The aqueous liquid will typically be water and it may contain one or more compounds chosen from an anti-bacterial agent, a fungicidal agent, a nutrient, an agent for setting a desired osmolarity, and a wound-healing agent. It is preferred that the primary end is supplied with aqueous liquid, which facilitates insertion into a secondary end that is provided with a band, in particular tape. It is preferred that the milling bit for machining the primary end is supplied with aqueous liquid during machining. It is preferred that the milling bit for the secondary end is supplied with aqueous liquid after machining. Aqueous liquid is typically provided using one or more outlet supply conduits from which jets of aqueous liquid are discharged. Typically at least 0.5 ml of aqueous liquid will be used per milling bit per milling operation, such as at least 2 ml. The amounts can be relatively low if a nozzle is used with aqueous liquid under a pressure of at least 1 bar. However, it is possible to easily discharge of water and milling debris (the amount of which will depend on the thickness of the element to be milled), when the amount of liquid is preferably at least 5 ml per milling bit per milling operation.

It is preferred that the scion is supplied towards a robot arm using a conveyor, wherein the conveyor is provided with devices for holding a scion, wherein the devices for holding scions are attached at known locations of the conveyor along the width of the conveyor, and devices for holding a scion are devices capable of centering the centerline of the scion with said locations, wherein a scion is picked from a device for holding a scion and moved to the milling bit for machining said scion.

This simplifies the milling operation as the centerline is thus known for passing the scion along a milling bit.

Finally the invention relates to an apparatus for performing the above method. More specifically, the invention relates to an apparatus for preparing a scion and a stock for grafting, said apparatus comprising milling bits for providing the scion and the stock with a wedge-shaped end and a complementary cut-out, actuators for driving the milling bits and at least one robot arm for handling a scion and a stock.

The apparatus preferably comprises one or more sensors (such as camera’s comprising sensors) to determine the thickness and orientation of an element chosen from a scion and stock, and a processing unit for processing the data to determine the orientation and trajectory to create the complementary shapes. The invention also relates to any embodiment discussed in relation to the method claims discussed above in any combination.

It is preferred that the apparatus comprises at the location of at least one milling bit a supply conduit for supplying an aqueous liquid.

Thus the milling bit can be cleaned during or after a milling operation.

It is preferred that the apparatus comprises a chamber containing the at least one milling bit, said chamber having an access opening for inserting the element to be machined, the supply conduit opening up in said chamber.

Thus the rest of the apparatus is not soiled by the aqueous liquid and/or debris, and the aqueous liquid with debris can be easily discharged via a discharge opening in the chamber. Such a chamber typically has a volume of less than 60 liters, preferably less than 30 liters, more preferably less than 10 liters and most preferably less than 3 liters.

It is preferred that the apparatus also comprises a device for aspiring the aqueous liquid emanated from the supply conduit.

Thus a sub-atmospheric pressure in the chamber is maintained, further preventing soiling of the rest of the apparatus.

Advantageously the chamber is provided with a discharge conduit connected to the device for aspiring the aqueous liquid.

### BRIEF DESCRIPTION OF THE DRAWINGS

The invention will be illustrated with reference to the drawings listed below.

FIG. 1A shows a top view on an apparatus for stem grafting comprising two robot arms;

FIG. 1B shows a longitudinal cross-sectional view of the apparatus of FIG. 1A;

FIG. 1C shows a longitudinal cross-sectional view of the apparatus of FIG. 1A in the opposite direction of FIG. 1B;

FIG. 1D shows a perspective view of a detail of the apparatus of FIG. 1A;

FIG. 1E shows a perspective view of the robot arms of FIG. 1A;

FIG. 2A shows a perspective view of a device for machining cut-outs;

FIG. 2B shows a perspective view of a device for machining primary ends complementary to the cut-outs machined using the device of FIG. 2A;

FIG. 2C shows a perspective view of a detail of the device for machining cut-outs of FIG. 2A;

FIG. 3A shows a perspective view of a detail of the device of FIG. 2A illustrating how cut-outs are machined;

FIG. 3B shows a perspective view of a detail of the motor of FIG. 2B illustrating how primary ends complementary to the cut-outs are machined;

FIG. 4A shows a secondary end of an element comprising a cut-out machined with the device of FIG. 2A;

FIG. 4B shows a machined primary end of an element complementary to the cut-out of the element shown in FIG. 4A;

FIG. 5 shows a machine for providing a secondary end with a band;

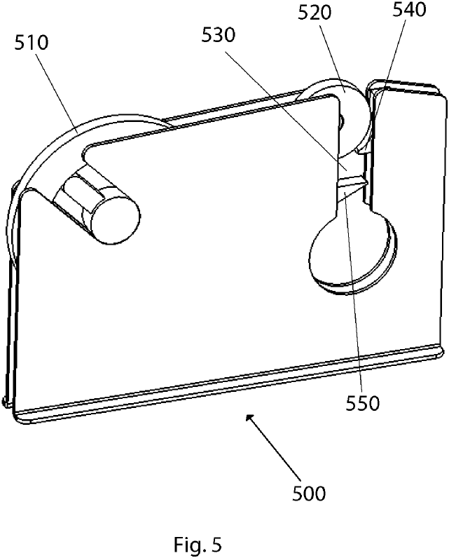

FIG. 6A shows a perspective view on a stock provided with a band;

FIG. 6B shows a perspective view of the stock of FIG. 6A provided with a scion;

FIG. 7 shows a side view of a device for machining primary ends;

FIG. 8 shows a perspective view of a detail of an apparatus 100 for stem grafting;

FIG. 9A show a perspective cut-out view of the chamber of FIG. 8;

FIG. 9B show a perspective cut-out side view of the chamber of FIG. 9A;

FIG. 10A shows a device for holding a scionin perspective view;

FIG. 10B shows a device for holding a scion in side view;

FIG. 10C shows a device for holding a scion in cross-sectional view;

FIG. 11A shows a perspective view of milling bits for milling a primary end; and

FIG. 11B shows a perspective view of milling bits for milling a primary end

### DESCRIPTION OF THE INVENTION

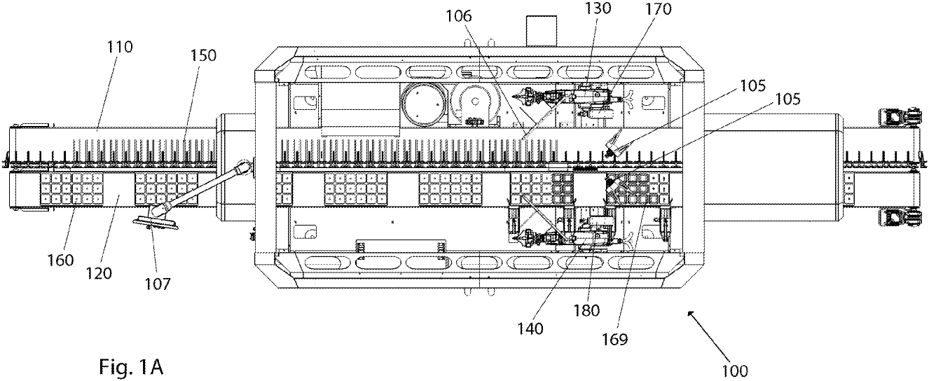

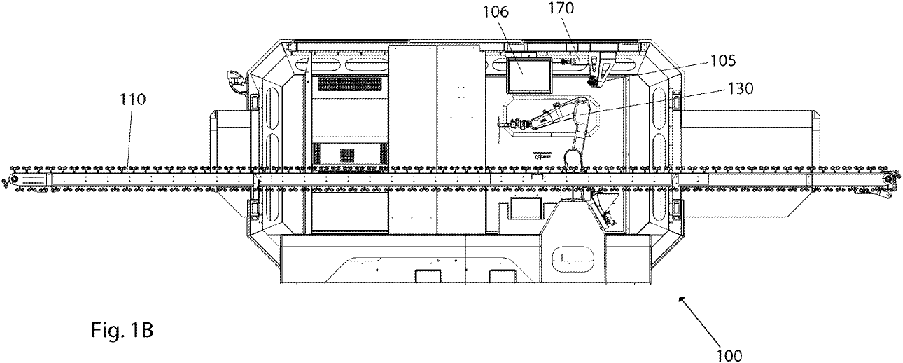

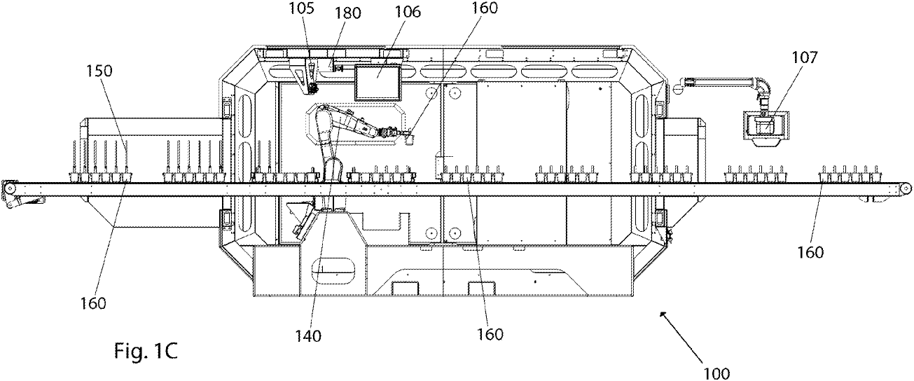

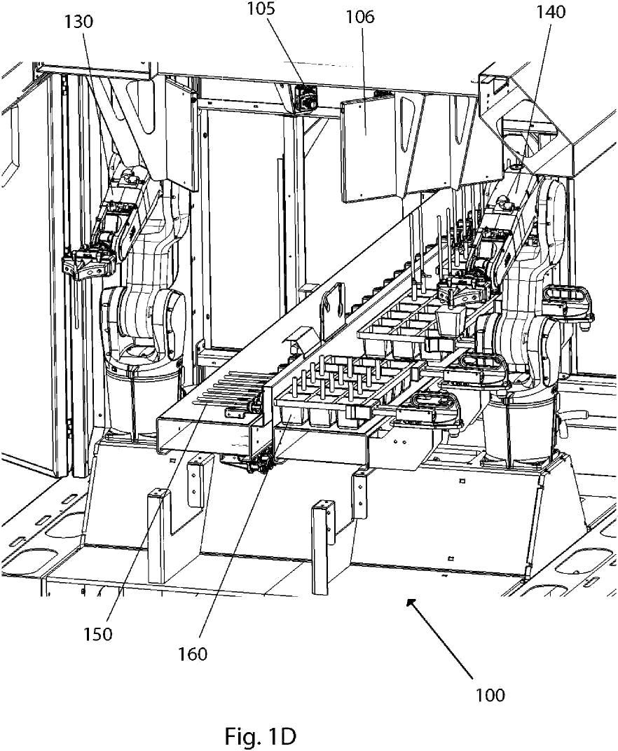

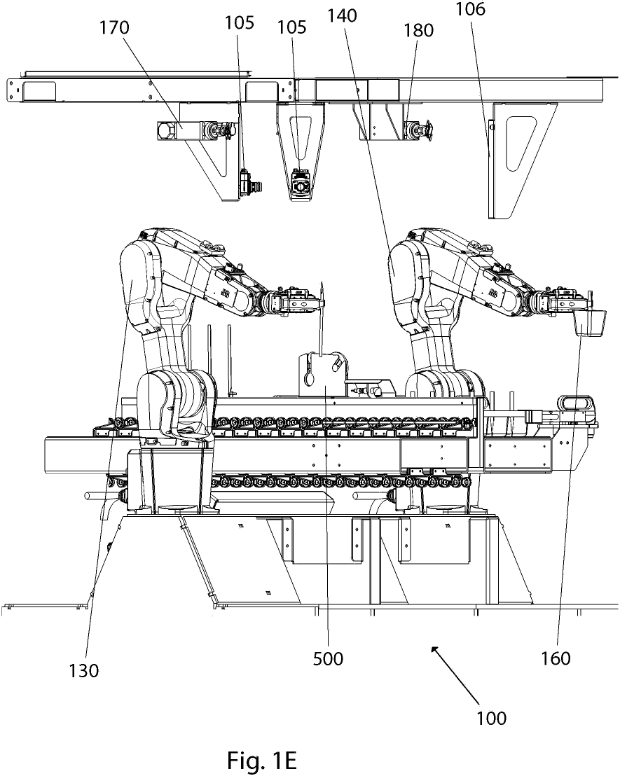

FIG. 1A to FIG. 1E show various views of an apparatus 100 for stem grafting comprising a first conveyor 110 for supplying scions 150 and a second conveyor 120 for supplying trays 169 with stocks 160. Once the stem graft operation has been performed, the trays 169 comprising grafted stocks are transported further using a conveyor, typically the second conveyor 120.

The scions 150 are picked up using a first robot arm 130 and the stocks 160 are picked up using a second robot arm 140. Scions and stocks are referred to as elements.

Usually the stocks 160 are provided with a cut-out, and the cut-outs are machined using a device 180 comprising with a machining bit as detailed below, whereas the complementary scions 150 are provided with primary ends complementary to said cut-outs using a device 170 comprising provided with machining bits (router bits) as detailed below.

It is in general important to take the diameters of the scion and the stock in consideration. To this end the apparatus 100 comprises two cameras 105, here at 90° with respect to each other and aimed at light screens 106 to provide contrast. A robot arm can hold an element between the cameras and the light screens 106, and output from the cameras is used to determine the various parameters relevant for machining and grafting. This comprises typically at least the thickness of the element. It is also possible to determine the location of the end with respect to the robot arm (distance to the distal end of the robot arm; angle with respect to the robot arm) so as to establish where the centerline of the end for grafting of the element and the end of the element are. The data are processed using a processing unit 107. Now the robot arm moves the element to a motor to be machined. After machining the stock, it is provided with tape from a tape dispenser 185 after which the machined end of the scion is received in the cut-out and secured by the tape.

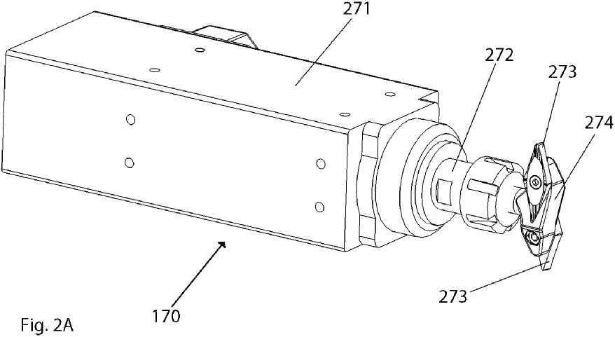

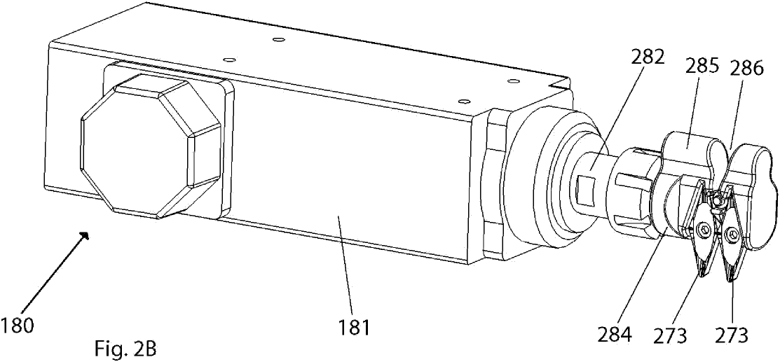

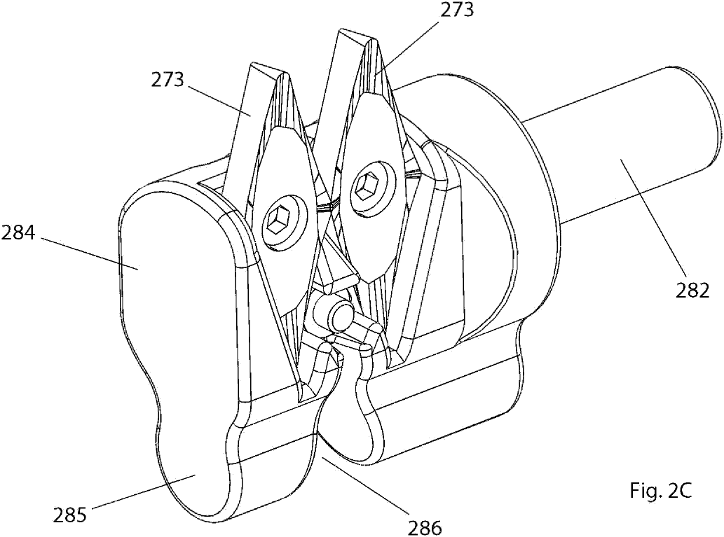

FIG. 2 shows perspective views of devices for machining elements. FIG. 2A shows the device 170 for machining a wedge-shaped cut-out in an element. The device 170 comprises a motor 271, and an axle 272. The axle 272 is provided with a machining cutters 273 (here two), which are mounted to mounting body 274. The machining cutters 273 were made by Iscar (VCGT 220508-AF) and are V-shaped with a taper angle α of 35°. The distal ends of the machining blades face away from the axle 272 and are equidistant to the axis of rotation of the axle 272. The bottom of the wedge-shaped cut-out is rounded (radius 0.8 mm) which helps to avoid the stock from being split during grafting.

FIG. 2B is substantially the same, except that device 180 comprises motor 181 and a pair of adjacent machining blades 273 mounted to mounting body 284 attached to axle 282. The cutting edges of the machining blades facing each other are at an angle that is the same as angle α (35°). This allows for machining a wedge-shaped end to an element complementary to the cut-out that is machined by device 170.

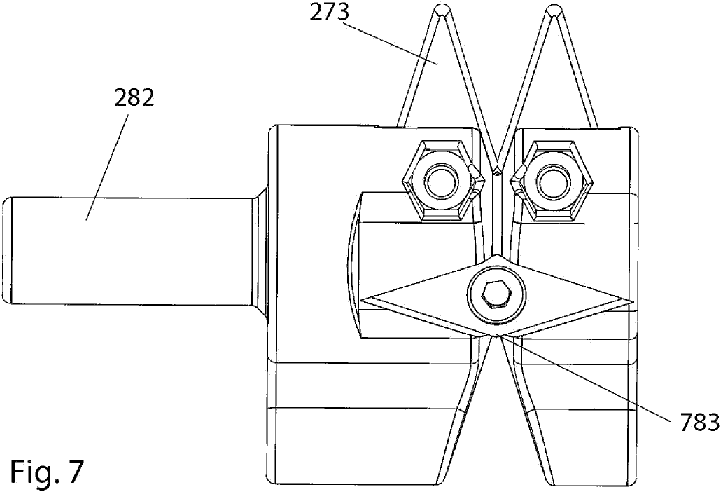

The mounting body 284 comprises a lobe 285 (FIG. 2C) to compensate for the protruding machining cutters, so as to bring the center of gravity back in line with the axis of rotation. The lobe 285 comprises a recess 286 wide enough to allow passage of elements machined. At the nadir of the recess there is a machining blade (as discussed with reference to FIG. 7) for rendering the edge formed by the two adjacent machining blades 273 blunt.

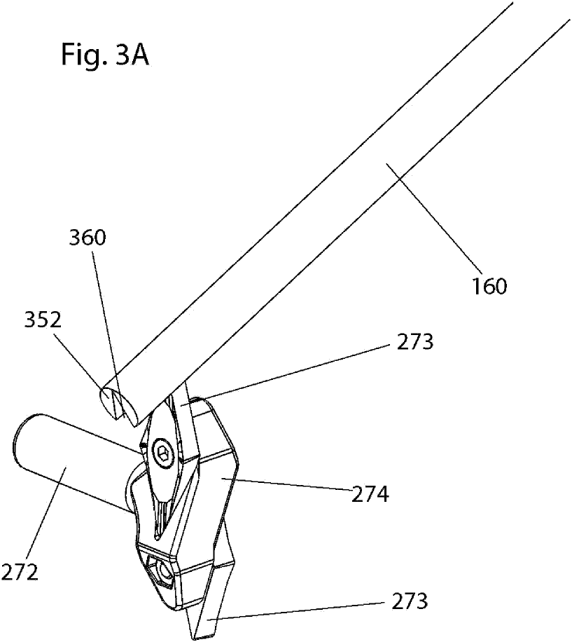

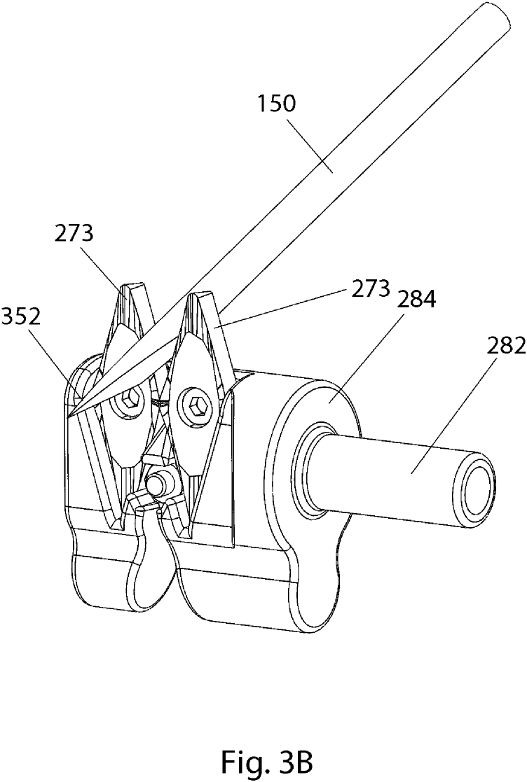

FIG. 3A and FIG. 3B illustrate machining an end of an element. The distal end of the stock 160 (proximal root system not shown) is provided with a wedge-shaped cut-out 360 at proximal end for grafting 362 there in here in a distal end section of a stock 160, using the device 170. The distal ends of the machining cutters 273 rotate in a plane transverse to the axis of rotation, and the distal end section of the stock 160, more specifically its centerline is aligned by the robot arm 140 in said plane of rotation. The robot arm 140 moves the end section tangential to the axis of rotation of the motor 171 so as to intersect with the trajectory of the distal ends of the machining blades 273, thus forming a wedge-shaped cut-out 360 (secondary end).

In a similar manner the scion 150, more specifically the centerline of its proximal end section, is aligned in a plane halfway between the two planes of rotation defined by the machining cutters 273 of the device 180 so as to form the complementary wedge-shaped end 350 (the primary end 352). The robot arm 130 moves the proximal end section tangential to the axis of rotation of the motor 181 so as to intersect with the trajectories of the distal ends of the machining cutters 273, thus forming a wedge-shaped proximal end section (primary end) complementary with the cut-out 360. The maximum depth of the wedge-shaped cut-out 360 at its distal end will be equal to the full diameter of the scion 150 at its proximal end section.

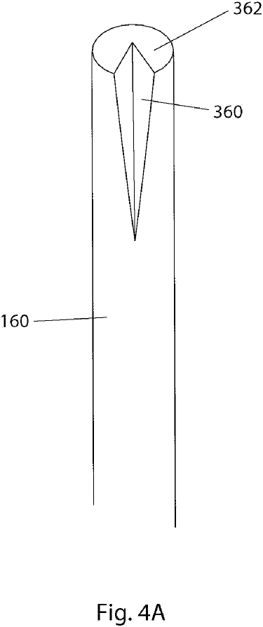

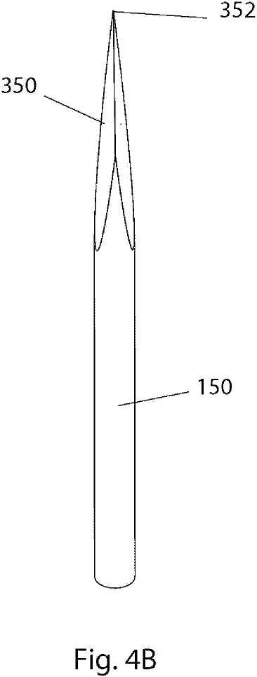

FIG. 4A and FIG. 4B show perspective views of the respective machined end sections of the stock 160 (partially shown) and the scion 150.

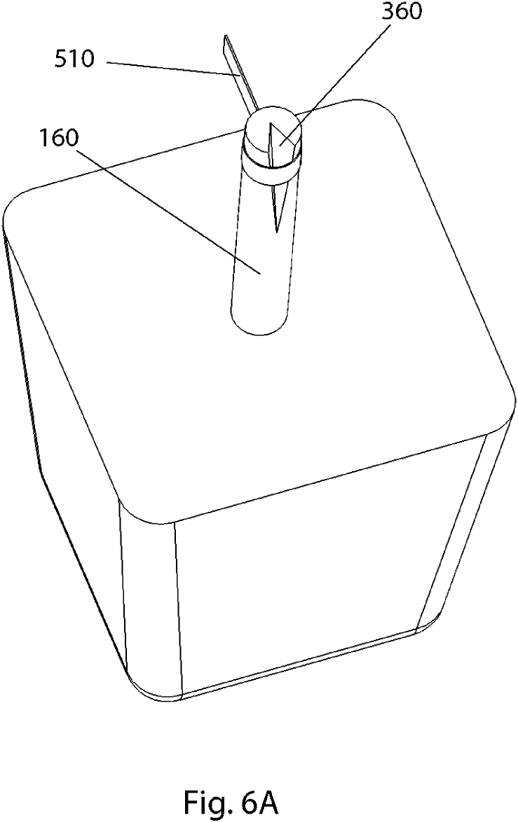

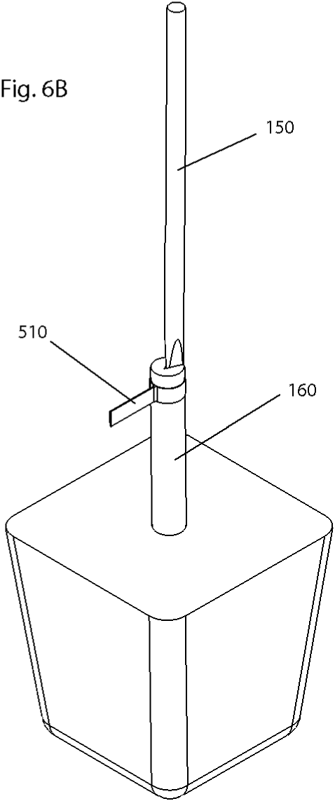

In accordance with the embodiment discussed here, after the primary end of the scion has been received in the cut-out, the scion is held in place using a band 510, here tape 510. To this end, use is made of a closing device 500 that is known in the art for closing bags (e.g. plastic bags containing bread). The tape 510 is placed with its backing on a roll 520. To accommodate for varying thickness of stock, the roll comprises a circumferential layer of resilient foam. The distal end of the stock is passed through a slot 530, in contact with the tape 510. A first lever 540 pushes the tape against the stock and finally against the tape itself. A second lever 550 controls a knife that cuts the tape 510. Thus the band 510 extends across the cut-out 360 of the stock 160 (FIG. 6A). Now the robot arm 130 inserts the primary end into the cut-out 360, completing the grafting operation. The grafted stock is placed into the tray by the robot arm 140 and the wound is given time to heal while being held by the band 510 (FIG. 6B).

It is preferred that an aqueous liquid is provided to milling bits during machining the scion 150. The scion 150 will be wet and the tape 510 will not easily stick to the scion 150 during insertion in the stock 160.

It is preferred that an aqueous liquid is provided to the milling bit after machining the stock 160 to clean the milling bit, so the stock 160 will remain dry and the tape 510 will hold onto the stock 160.

The scion has two faces that taper in a plane transverse to the longitudinal direction of the scion. To reduce the risk that the scion splits the stock, according to a preferred embodiment a second bit 773 is used for cutting the apex of the primary end. This renders the apex blunt. To this end it is preferred that the device 170 for machining a wedge-shaped cut-out comprises said second bit 773, allowing the primary end to be formed in one machining operation. The particular shape of the blunt apex is not of particular importance but it is desired that it does not protrude into the rounded section of the wedge-shaped cut-out.

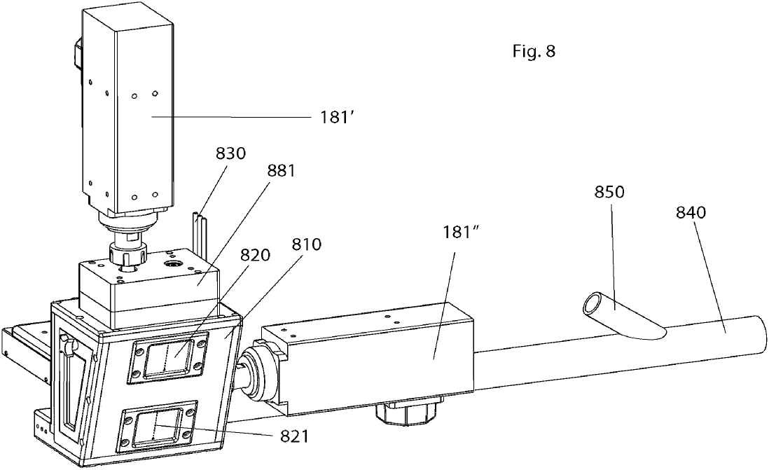

FIG. 8 shows a perspective view of a detail of an apparatus 100 for stem grafting, and in particular a preferred embodiment, wherein the milling bits are in a chamber 810, with a volume of about 1 liter. In the embodiment discussed here, the chamber 810 has two access openings 821 (slits) in rubber sheets 820, the access opening 821 allowing insertion of an element into the chamber 810 for performing milling operations. The apparatus 100 has three supply conduits 830 for supplying water (aqueous liquid) to the milling bits, and a discharge conduit 840 for removal of water and milling debris from the chamber 810. In the embodiment discussed here, the water is removed by introducing air via an air conduit 850, causing sub-atmospheric pressure inside the chamber 810, which will help to avoid spilling of water via the access openings 821 from the chamber 810.

881 refers to a gearbox so as to drive two conical milling bits 273 with drive motor 181′ as will be explained below.

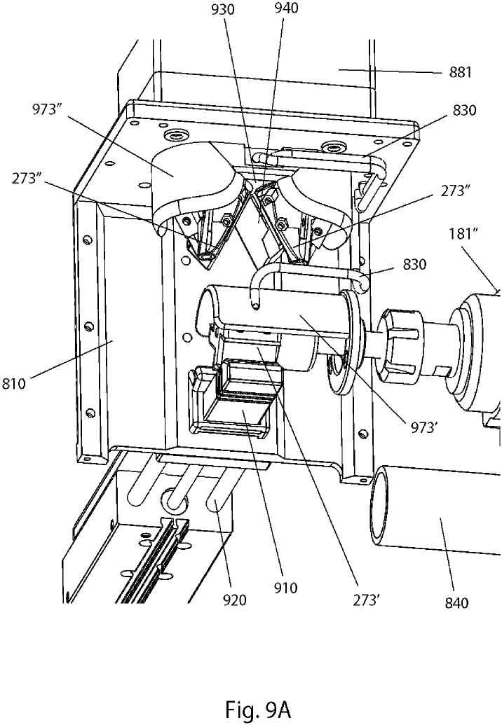

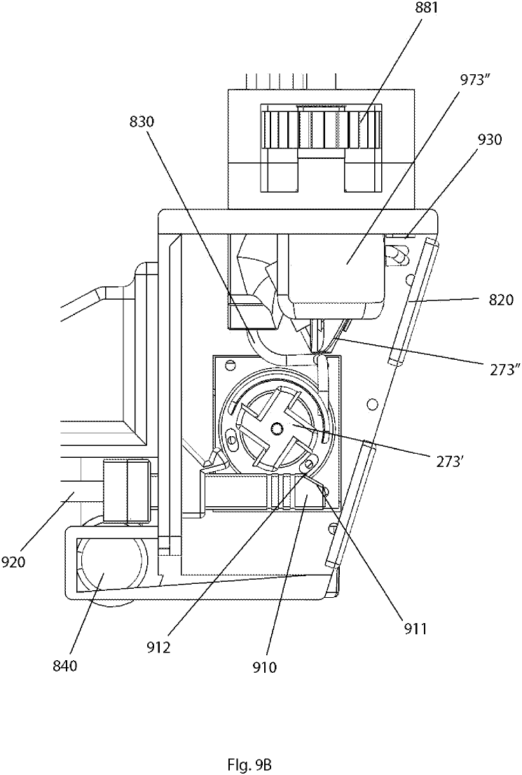

FIG. 9A show a perspective cut-out view of the chamber 810 of FIG. 8 and FIG. 9B cut-out side view of the chamber of FIG. 9A.

The milling operations performed in the chamber 810 are as follows. The end of the scion to be machined is introduced via the slit 821 into the chamber 810. It is placed with its circumferential side on a chamfered support surface 911 of a moveable air piston 910 which is moveable in a direction dictated by guides 920. The support surface 911 comprises a stop 912. The end to be machined of the scion is placed against said stop 912 and horizontal movement of the scion by the robot arm pushes the air piston in (to the left in FIG. 9B). In particular with relatively thick scions the use of a support surface is not necessary. The machining blade 273′ (operated at 6000 rpm) machines the end of the scion, resulting in an oblique machined surface on the scion. The most distal end is not machined and according to the present invention this is advantageous as it will mean that said tip is strong and thus well defined. There will be less interference by fibers that may result due to the milling process.

The oblique machined surface is now placed against top surface 940 of the chamber 810 and moved horizontally towards two conical milling bits 973″, operated at 8000 rpm). These are spaced apart and the closest distance between the milling bits 973″ ensures that the wedge-shape is not sharp, so as to avoid the risk of splitting the stock. While moving (using the robot arm) the end of the scion to be machined tangential to the axes of rotation of the milling bits 973″, the machined end section that has passed the milling bits 973″ is in contact with the inner surfaces of a V-shaped guide, which prevents the end of the scion from moving laterally during machining, resulting in a more defined wedge-shape. Subsequently the robot arm moves the scion back along the same path, and inserts the scion into the wedge-shaped groove of the stock.

During machining water is introduced via the conduits 830 (33 ml per milling bit per milling operation, which ensures wetting of the back of the scion, which is convenient when the scion is inserted into the groove and held by tape wrapped around the stock.). Shields 973 divert the water introduced on the milling bits in the chamber 810 as well as milling debris downward to the bottom of the chamber where it is discharged using the discharge conduit 840. The rubber sheets 820 help to prevent debris from spoiling the rest of the apparatus, helped by the fact that air will enter the chamber via the slits.

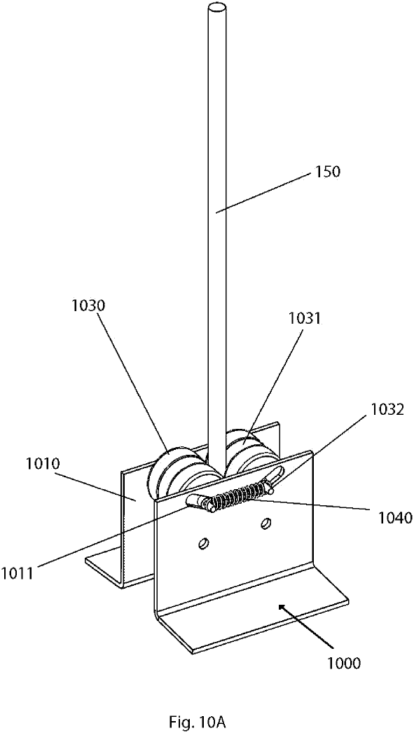

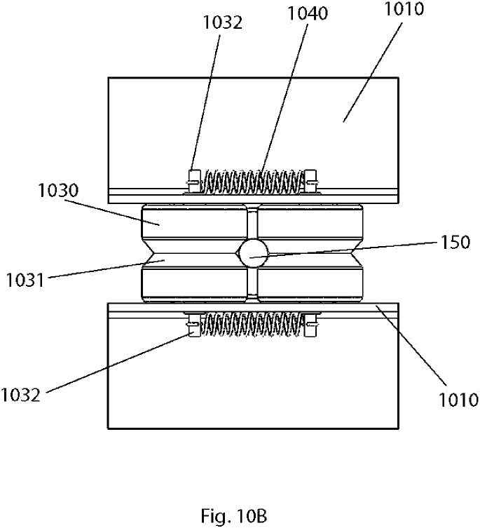

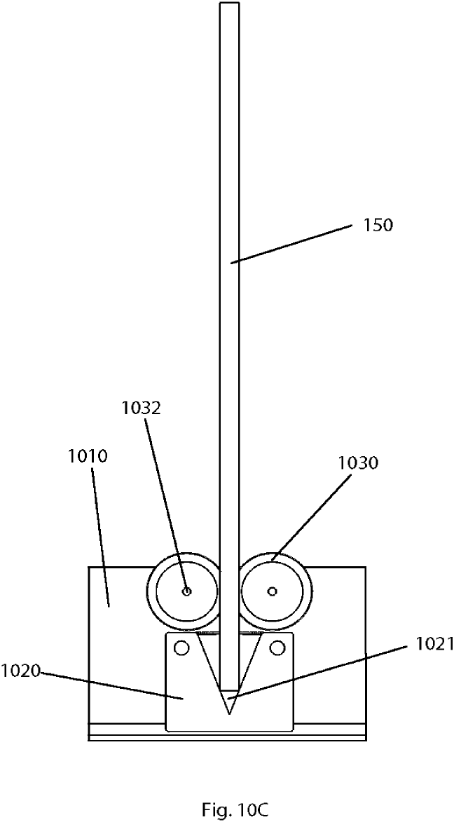

While in the embodiment discussed with reference to the scions shown in FIG. 1A on the conveyor belt in a horizontal position, picking up using a robot arm may be facilitated by having the scion 150 oriented substantially perpendicular to the surface of the conveyor belt. If the conveyor belt is stopped at predetermined positions, the location of the scion 150 in X and Y direction can be known. It is advantageous to have the centerline of the scion coincide with these locations. To this end it is preferred to provide the conveyor belt with a device 1000 for holding a scion. The device is shown in perspective view in FIG. 10A, in side view in FIG. 10B and in a cross-sectional view in FIG. 10C. The devices for holding a scion are attached at known locations of the conveyor along the width of the conveyor, and devices 1000 for holding a scion are devices capable of centering the centerline of the scion with said locations. In operation, the conveyor belt is stopped and the scion 150 is picked from the device 1000 for holding a scion and moved to the milling bit for machining said scion.

The device 1000 for holding the scion is capable of centering the scion 150. The device 1000 comprises two L-shaped brackets 1010 and at a lower end of the device there is a stop 1020 with a tapered recess 1021 that receives an end of the scion 150. At a distance from said stop 1020 there are two wheels 1030 that have a tapered groove 1031 for receiving the end of the scion to be inserted into the stop and for centering the part of the scion 150 protruding from said stop 1020. To this end, the wheels 1030 have axles 1032 that are moveably mounted in angled slots 1011 in the brackets 1010. The slots 1011 are at an angle to the surface of the conveyor belt, typically in a range between 20° and 70°, preferably 45°; and an angle between the slots between 40° and 140°, preferably 90°. Both axles 1032 are connected with two springs 1040. The most stable position of the axles 1032 is with a plane defined by both axles 1032 parallel to the surface of the conveyor belt, irrespective of the thickness of the scion. In the direction of movement of the conveyor belt, the scion is centered by the tapers of the grooved wheels 1030.

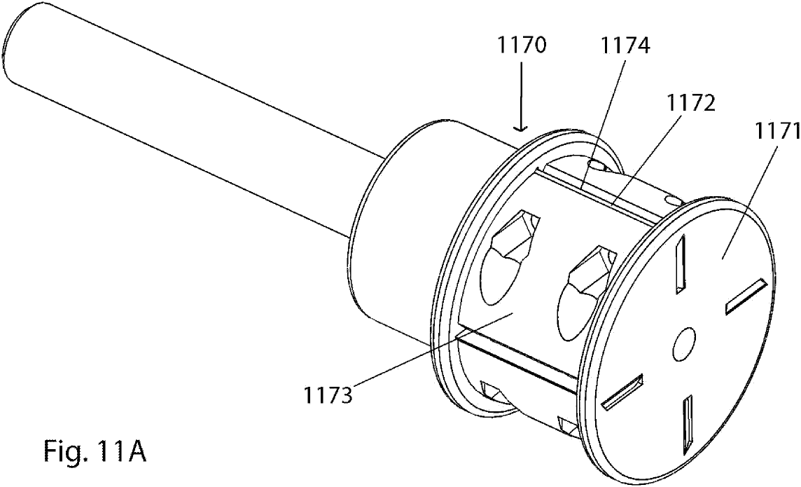

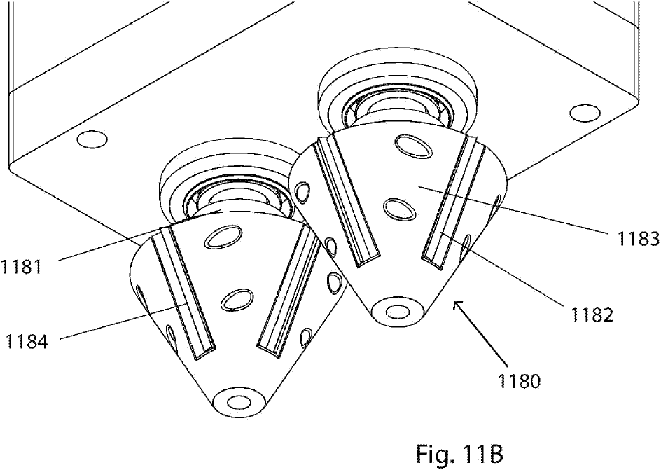

According to a preferred embodiment of the invention, the primary end is shaped by milling with a milling bits having guide surfaces as shown in FIG. 11A to form a first cut surface in a first step, and with a second milling bit having guide surfaces to form cut surfaces complementary to the wedge-shaped cut-out in a second step.

The milling bits 1170, 1180 comprise mounting bodies 1171, 1181 provided with (four) machining blades 1172, 1182. Located between the machining blades are guide surfaces 1173, 1183 which are at a distance to the rotational axis of the milling bits that is 0.5 mm less than the edges 1174, 1184 of the machining blades 1172, 1182. The thin tapered end of the primary end formed during the first and/or second step has a tendency to vibrate and the guide surfaces 1173, 1183 suppress this and thus improve cuts with a reduced risk of fibrous tails and further resulting in smoother machined cut surfaces.

What is claimed is:

1. A method of stem grafting a scion to a stock, wherein the method comprises the steps of:
shaping an end for grafting of an element chosen from i) a proximal end of the scion and ii) a distal end of the stock to result in a shaped primary end, and
providing the end for grafting of the other element with a cut-out, wherein said cut-out extends
in a longitudinal direction of the other element at a circumferential side thereof, and
through the bark of the other element so as to result in a secondary end; said cut-out of the secondary end being complementary to the primary end, and
inserting the primary end in the complementary cut-out of the secondary end;
wherein of the primary end and the secondary end at least the cut-out of the secondary end is obtained by machining using a milling bit.

2. The method according to claim 1, wherein the milling bit for forming the cut-out has a first cutting edge and a second cutting edge, said cutting edges being at an angle α of less than 170° for forming a wedge-shaped cut-out.

3. The method according to claim 1, wherein the milling bit has a distal end, the milling bit is rotated about an axis wherein the distal end of the milling bit defines a plane of rotation, the milling bit is off-center with respect to the axis of rotation and its distal end facing away from the axis of rotation, wherein before milling the element and the plane are positioned relatively to each other with the centerline of the element in said plane and while milling the element and the axis of rotation are moved relative to one another along a line of movement with the centerline of the element in said plane of rotation in a direction from the end for grafting of the element to an opposite end of the element wherein the line of movement intersects the centerline of the element.

4. The method according to claim 3, wherein milling the primary end comprising milling using a milling bit comprising a multitude of machining blades, the machining blades having distal ends equidistant to the axis of rotation and distributed over the rotational direction of the milling bit, wherein the machining blades are separated by guide surfaces and wherein for a given location on the axis of rotation the radial distance between the distal end of a machining blade and the guide surfaces is between 0.05 and 1.5 mm, preferably between 0.1 and 0.5 mm and more preferably between 0.15 and 0.4 mm.

5. The method according to claim 4, wherein in a first milling step the shaped primary end is formed
in a first step involving rotating a first milling bit having guide surfaces to form a first cut surface, and
in a second step involving rotating a second milling bit having guide surfaces to form cut surfaces complementary to the wedge-shaped cut-out.

6. The method according to claim 1, wherein the angle α is less than 100°, preferably between 15° and 60° and more preferably between 20° and 45°.

7. The method according to claim 1, wherein the primary end is obtained by machining using at least one milling bit, the at least one milling bit comprising two cutting edges at an angle to provide the shaped primary end complementary to the cut-out of the secondary end.

8. The method according to claim 1, wherein the wedge-shaped cut-out is machined with an angle α′, and the complementary wedge-shaped primary end is machined with an angle α″, wherein the difference between angle α″ and angle α′ is between +0.2° and 3°, preferably between +0.3° and 1°.

9. The method according to claim 1, wherein the apex of the primary end in a plane perpendicular to the longitudinal direction of the other element is at a distance from the other element.

10. The method according to claim 9, wherein the milling head comprises a second bit for cutting the apex of the primary end.

11. The method according to claim 1, wherein the nadir of the cut-out is in a plane perpendicular to the longitudinal direction of the other element rounded with a radius of at least 0.2 mm.

12. The method according to claim 1, wherein the thickness of at least the thinnest of the element and the further element is determined using an auxiliary device and the thickness value that is determined is used in the control of the machining bit.

13. The method according to claim 1, wherein the secondary end of the other element is provided with a band across the cut-out before inserting the primary end of the element.

14. The method according to claim 1, wherein the milling bits are rinsed during and/or after cutting with an aqueous liquid supplied via at least one supply conduit.

15. The method according to claim 1, wherein the scion is supplied towards a robot arm using a conveyor, wherein the conveyor is provided with devices for holding a scion, wherein the devices for holding scions are attached at known locations of the conveyor along the width of the conveyor, and devices for holding a scion are devices capable of centering the centerline of the scion with said locations, wherein a scion is picked from a device for holding a scion and moved to the milling bit for machining said scion.

16. An apparatus for preparing a scion and a stock for grafting, said apparatus comprising milling bits for providing the scion and the stock with a wedge-shaped end and a complementary cut-out.

17. The apparatus according to claim 16, wherein the apparatus comprises at the location of at least one milling bit a supply conduit for supplying an aqueous liquid.

18. The apparatus according to claim 16, wherein the apparatus comprises a chamber containing the at least one milling bit, said chamber having an access opening for inserting the element to be machined, the supply conduit opening up in said chamber.
